(19) United States
(12) Patent Application Publication
(10) Pub. No.: US 2012/0123588 A1
(43) Pub. Date: May 17, 2012

(54) COMMUNITY-BASED PLATFORM FOR CUSTOM ITEM DEVELOPMENT AND DISTRIBUTION

(75) Inventors: Michael E. Cloran, Zionsville, IN (US); Nathan J. Altman, Indianapolis, IN (US); Ankit Gupta, Carmel, IN (US); Michael A. Mitchell, Carmel, IN (US)

(73) Assignee: ZOODEA, LLC, Carmel, IN (US)

(21) Appl. No.: 13/298,218

(22) Filed: Nov. 16, 2011

Related U.S. Application Data
(60) Provisional application No. 61/414,131, filed on Nov. 16, 2010.

(51) Int. Cl. G06F 17/00

(52) U.S. Cl. 700/233

(57) ABSTRACT

A system is described that uses data connectivity of dispensing units and an online community of users to develop, publicize, distribute, test, customize, and popularize user- and company-created, custom-formulated items. In one example, users can use “Build a Drink” software to create their own drink formulas from a palette of three or more ingredients, preferably dozens. They make custom designs for the labels on the beverage containers. Users/purchasers in the community rate and comment on drinks they try, earn rewards for community participation, and share in the profits from sales of their designer drinks. Custom-formulated items are instantly available at the whole network of dispensing units (or a subset thereof) immediately upon publication of the custom formulation and/or label design. A social network of consumers and designers share and evaluate items, and a recommendation engine suggests purchases based on data available to system.

### REFERENCE TO RELATED APPLICATION

This application claims priority to U.S. Provisional Application No. 61/414,131, “Community-Based Platform for Custom Beverage Development,” filed Nov. 16, 2010, which is hereby incorporated by reference in its entirety.

### FIELD

The present disclosure relates to data processing systems or methods specially adapted for commercial purposes. More specifically, the present disclosure relates to beverage vending systems and methods.

### BACKGROUND

The beverage industry has recently experienced an explosion of flavors and brands, each appealing to a smaller and smaller niche segment of consumers. Beverage companies spend significant resources exploring and discovering new flavors and beverage concepts and testing those concepts against different populations. Very often these companies are forced to gear up production and branding shortly after performing flavor discovery, moving quickly from focus group to product launch.

Consumers frequently purchase soft drinks and other individual serving-sized beverages from vending machines and soda fountains. A number of factors in the design of present vending machines and soda fountains limit consumer choice via those outlets and create an expensive labor overhead for maintaining these devices.

Many beverage vending machines are expensive to service in large part because they require the transport of large amounts of heavy packaged liquids. Individuals known as “rack jobbers” travel from machine to machine to service each in turn, facing the tedious and time-consuming task of reloading each individual bottle or can by hand. Once any one product in the machine runs out, the machine requires service. The vast majority of today's vending machines cannot report their status to a facility that can dispatch service technicians only when needed, so frequent check-ups are necessary.

Current vending machines are also inherently limited in the options they can make available to the consumer. The more products and greater variety offered by a vending machine, the smaller the number of each selection present, since all products are competing for the same limited space in the same machine. Adding more choices also raises the service overhead further since, as noted above, once any one product is out of stock, the machine needs a service call in order to be restocked.

The costs involved in servicing and maintaining vending machines further limit consumer choice since they act as a barrier to entry for many emerging beverage companies. Small-scale manufacturers of drinks with niche appeal simply can't afford the overhead vending machines impose.

When corporate campuses, universities, or other sites want to install a vending machine, the limitations of some vending machine systems mean the first debate is between which of the available beverage vendors to select. Once a vendor has been selected, decisions must be made about which of the vendor's brands and products to stock in the machine. Some selections always lose since the most popular selections have to be among the six to eight options most machines support. Some healthier choices may be edged out by the “must-have” sweetened selections—a particular concern for vending machines located in schools.

Sales data from a vending machine is often only available per service cycle, and nearly all of that data is devoid of demographic information. Companies know how much of a given drink sold in a particular span of time, but little else. For example, they do not know what was more popular at a particular time of day, nor about who was making these purchases, etc.

This lack of reporting and visibility of sales at the machine extends to a general lack of built-in monitoring or safety systems for vending machines. Current vending machines are designed to operate unattended and frequently contain both cash and desirable items, and they are thus popular targets for petty vandalism.

Soda fountains, one common alternative to vending machines, require careful maintenance due to health concerns, and also present consumers with the same limited range of selections as vending machines.

### BRIEF DESCRIPTION OF THE DRAWINGS

FIG. 1 is a schematic diagram of a custom beverage system according to a first embodiment.

FIG. 2 is a high-level schematic diagram of a dispensing unit in a second embodiment.

FIG. 3 is a schematic diagram of the community platform used with the dispensing unit of FIG. 2, and high-level components thereof, and devices interacting therewith.

FIG. 4 is a schematic diagram of a container feeding system for use in the embodiment of FIG. 2.

FIG. 5 is a schematic diagram of a beverage production mechanism for use in the embodiment of FIG. 2.

FIGS. 6A-6C are an illustration of in-container ice produced by some implementations of the embodiment of FIG. 2.

FIG. 7 illustrates the components of computing devices in many custom beverage systems according to the present disclosure.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

Generally, one form of the present system is a custom beverage design and dispensing system supported by a social network of beverage designers and consumers. Individual users, corporate users, and other organizations can “design” beverages through a user interface and save formulas for “user-generated refreshment.” When a customer buys a beverage someone designed, the designer gains some benefit, “user-generated profit,” from the sale. “Limited edition” beverages customized for particular events can be made available in certain venues in conjunction with the events. A recommendation engine can suggest new beverages for users based on their own purchase history, ratings and reviews, friends' preferences, and all other information available in the system. Other embodiments allow design and dispensing of other items that include a mixture of ingredients dispensed in a container along similar lines.

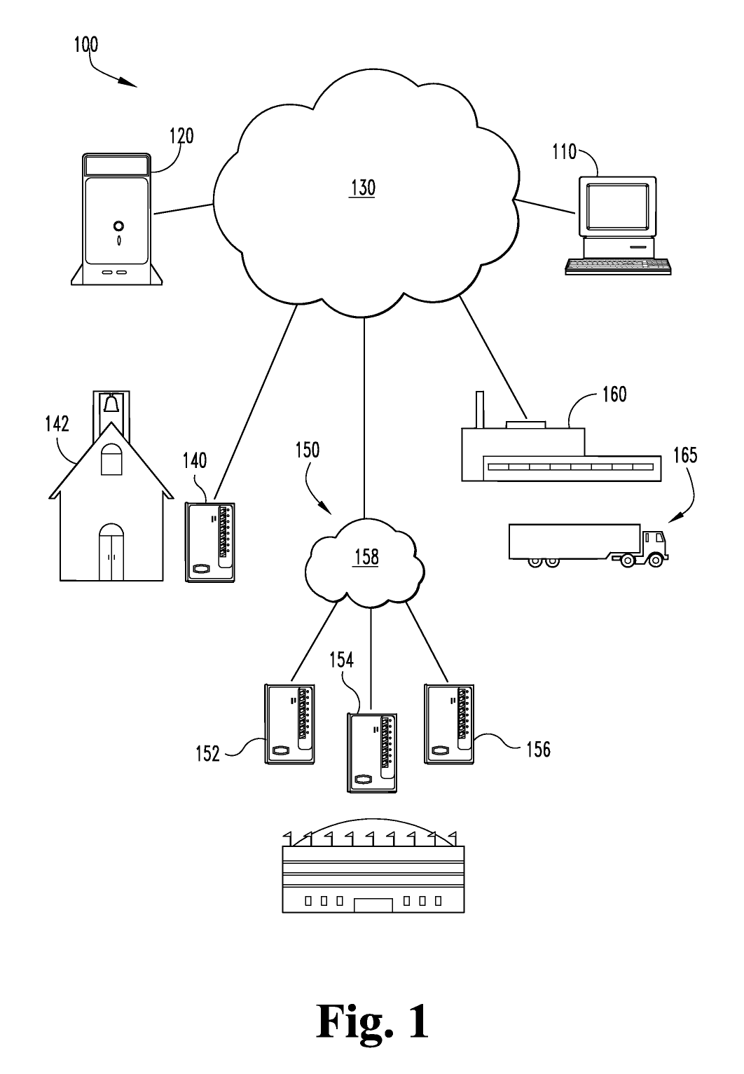

One embodiment of the system will be discussed with reference to FIG. 1. In system 100, a user operates a user interface on client computer 110, which communicates with server 120 through network 130 as will occur to those skilled in the art. The user interface accepts user input to create and change formulas for beverages. In this embodiment, the formulas are stored in a database on server 120 in association with a user account of their creators. In other embodiments, the formulas are stored in a data file on portable media, such as USB storage devices, printed QR codes, or other media as will occur to those skilled in the art in view of this disclosure. In some embodiments, the formula data is encrypted and can only be decrypted by the creator or those whom he or she authorizes, or in other embodiments it can be decrypted by those connected to him or her in a social network as will occur to those skilled in the art in view of this disclosure.

Dispensing unit 140 is situated in or near school 142, while dispensing units 152, 154, and 156 at venue 150 are connected by a wired and/or wireless local area network 158. Additional dispensing units (not shown) are installed at businesses, colleges, public areas, restaurants, and other locations currently served by beverage vending machines, as well as additional locations that will occur to those skilled in the art in view of the present disclosure. Each dispensing unit 140, 152, 154, and 156 is permanently or intermittently in data communication with server 120 through network 130. Additional dispensing units are situated at bulk production facility 160, from which vehicles 165 transport custom beverages to customers as described herein, and as will occur to those skilled in the art.

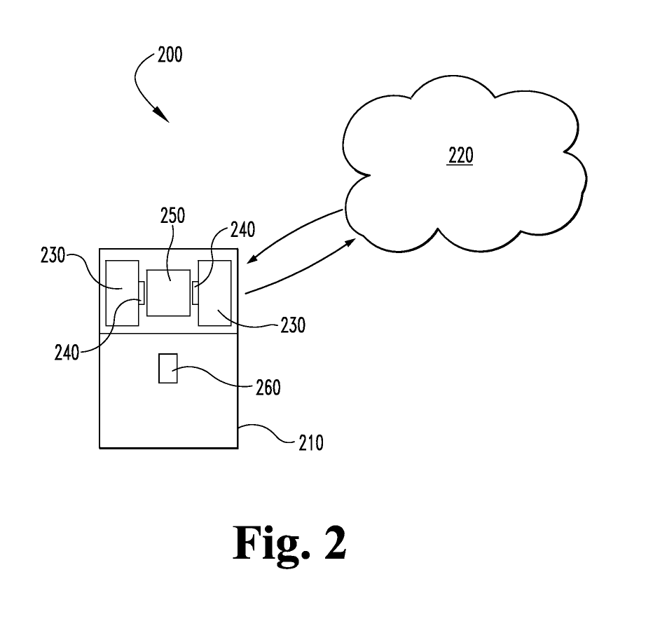

Generally, customers approach a dispensing unit and request a custom-made beverage (in any of a variety of ways), and the dispensing unit produces it, handling a payment transaction for the beverage either locally, via server 120, or using other means as will occur to those skilled in the art. FIG. 2 illustrates one such system 200, which includes dispensing unit 210 in communication with community platform 220 (which may be housed, for example, on one or more servers 120). Dispensing unit 210 is a vending machine form factor in this embodiment, and it is capable of producing almost any drink made available through community platform 220. Community platform 220 in this embodiment is an online user community comprising online community features known in the art, including but not limited to forums, discussion threads, ratings, how-to guides, FAQs, member profiles, member accounts, and additionally such community-themed content and tools as flavor recipes, drink ratings, “Build a Drink” beverage designer software, container label designer software, user demographic data, user history, user earnings statements, and a recommendation engine.

Dispensing unit 210 in this embodiment includes multiple touchscreens 230 and associated data readers 240 so that multiple users can interact with the unit 210 at the same time. In various embodiments, data readers 240 are configured to read information from magnetic-stripe cards, near-field communication (NFC) and/or RFID tokens, barcodes, QR codes, and other machine-readable data carriers in optical, magnetic, and other media as will occur to those skilled in the art. In various embodiments, the data collected by these readers includes formula data, customer identification information, membership information, redeemable coupons, reward cards, event tickets, and the like. Dispensing unit 210 also includes viewing window 250, through which purchasers can watch their beverage being made. When complete, the beverage is presented to the user at sending port 260.

In some embodiments, dispensing unit 210 includes water quality sampling equipment that can report water and ingredient characteristics electronically from the field to of reporting locations such as a server 120 (see FIG. 1) in community platform 220. Dispensing unit 210 periodically samples these characteristics and communicates them through network 130. Dispensing unit 210 also tracks lot information, expiration or “best by” dates, nutritional information, and other necessary or desirable information on each label produced, and that information is also communicated and registered with the server 120.

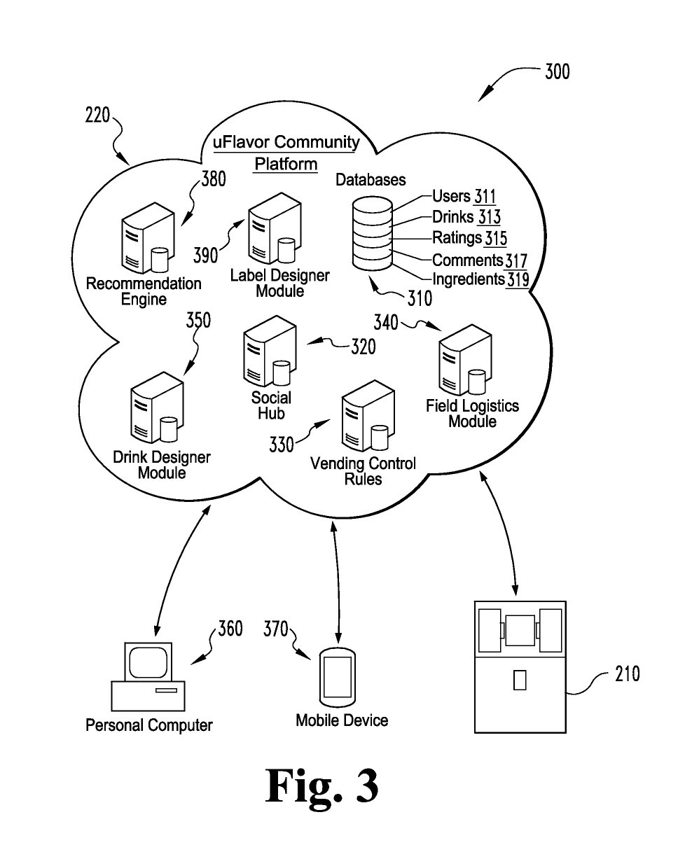

FIG. 3 illustrates more about certain elements of community platform 220 and interactions therewith. Dispensing unit 210 is in two-way communication with community platform 220, as discussed elsewhere herein. A number of databases 310 support community platform 220, including in this embodiment databases of users 311, drinks 313, ratings 315, comments 317, and ingredients 319. For example, users database 311 in the illustrative embodiment includes users' profiles, which each contain the user's identity; demographic and biographical data; one or more photographs (taken in some embodiments by dispensing units at the time of the purchase) and/or avatars; drink design history; purchase history; preferred payment method, which may include account information, pre-authorizations, and caps on expenditures, for example; “friends” and other associates in a social network; “badges” or “achievements” awarded because of activities in system 300 (such as beverages designed, drinks sold, friends added, designs rated highly, “liked” or commented-upon drinks that eventually became very popular or profitable, and the like), activities related to contests, games, or special programs of sponsors (such as videogame publishers or gaming systems) or others; and other user-specific information as will occur to one skilled in the art.

Drinks database 313 in this embodiment includes information particular to a particular beverage formulation by a particular user. Each entry includes a list of ingredients (by reference to ingredients database 319), the amount of each ingredient to include in a beverage, the creator of the beverage (for example, by reference to an entry in users database 311), customized text and/or graphics used to label containers when the drink is dispensed, the number of times the drink has been dispensed, the total selling price received for sales of the drink, incentives or rewards given to the drink designer in connection with the formulation, associations of the drink with particular promotions, an optional expiration date for the formulation, availability limitations on the drink, and other drink-specific information as will occur to those skilled in the art. In some embodiments, a single “drink” may have multiple “versions” all associated with the same “drink” entry, while in others, only a single formulation is associated with each record in drinks database 313. Some drinks may be associated with particular commercial brands, while others are not.

Ratings database 315 in this embodiment includes a list of ratings by users (for example, by reference to entries in users database 311) of particular drink formulations (for example, by reference to entries in drinks database 313), such as a selection of 1-5 “stars.” In some embodiments, the list also identifies the date and time at which the rating was given, the IP address of the computing device used to enter the rating, and a “weight” level that affects how strongly the rating influences other ratings.

Similar to ratings database 315, comments database 317 includes a list of comments on particular drinks (by reference to entries in drinks database 313) by users (by reference to entries in users database 311). In some embodiments, users are prompted to post comments and reviews on drinks they purchase in association with their user profiles. In others, users are free to comment on and review beverages even when there is no record that they have tried them. In some embodiments, when a comment or rating is posted, the creator of the drink is given notice by e-mail, text message, or other method as will occur to those skilled in the art.

Another portion of databases 310 is ingredients database 319. Ingredients database 319 includes names, logos and other graphics, nutritional information, classification information (such as a category name under which the ingredient should be listed), manufacturer/source/supply information, suggested quantity and/or concentration amounts, and other information about each particular ingredient used in the system. Still other databases and associations will be stored in databases 310 as will occur to those skilled in the art.

Social hub 320 is a collection of online resources for connecting users, beverages, and related activities and sponsors. For example, social hub 320 in some embodiments includes Bren without limitation) user forums, user groups, user profile search and display, recipes, how-to guides, image and video libraries, and other tools for user interaction and information sharing that will occur to those of ordinary skill in the art in view of this disclosure.

Vending control rules 330 determine eligibility of a user to purchase a particular drink at a given time from a dispensing unit in a known location. In some embodiments, rules 330 operate as a function of the age of the user, dietary restrictions imposed by an organization's administrators (for example, in the case of dispensing unit 140 near school 142), special offers related to particular events, whether a particular special event is ongoing, and other criteria as will occur to those skilled in the art in view of this disclosure.

Field logistics module 340 communicates with dispensing units 210 that are deployed in a variety of locations. Field logistics module 340 receives status information from dispensing units 210 about their supply levels, dispatching resupply shipments of consumables as necessary, coordinating software updates to the dispensing units 210, interfacing with remote video units in the dispensing units 210, and handling other alerts from dispensing units 210 in the field.

Drink designer module 350 implements the custom drink design (“Build a Drink”) software, which allows user to create their own custom beverage recipes. In various embodiments, drink designer module 350 communicates with users through user interfaces implemented via touchscreens 230 (in dispensing units 210 as shown in FIG. 2), custom applications on personal computers 360 or mobile devices 370, browser-based web apps on devices capable of rendering such content.

Recommendation engine 380 draws upon information in each user's profile, reviews, ratings, purchase history, and demographics; those aspects of users with similar histories to a requesting user; trends in the community; and other data as will occur to those skilled in the art to suggest beverages to the user. In “social network” style implementations, recommendation engine 380 also takes into account information in user profiles of those users with whom the particular user is connected (that is, their “friends”), their reviews, ratings, and purchase history, as well as the number of connections in and other characteristics of the user's “network.”

Label designer module 390 is a custom software application enabling users to customize the container labels for the beverages they design. Level designer module 390 in some embodiments offers themes, background images, fonts, color schemes, and other custom content as a function of the date, time, upcoming events, “badges” or “achievements” attained by the user, other factors considered by recommendation engine 380, and still other factors that will occur to those skilled in the art. In some embodiments, users can upload their own content for use on labels.

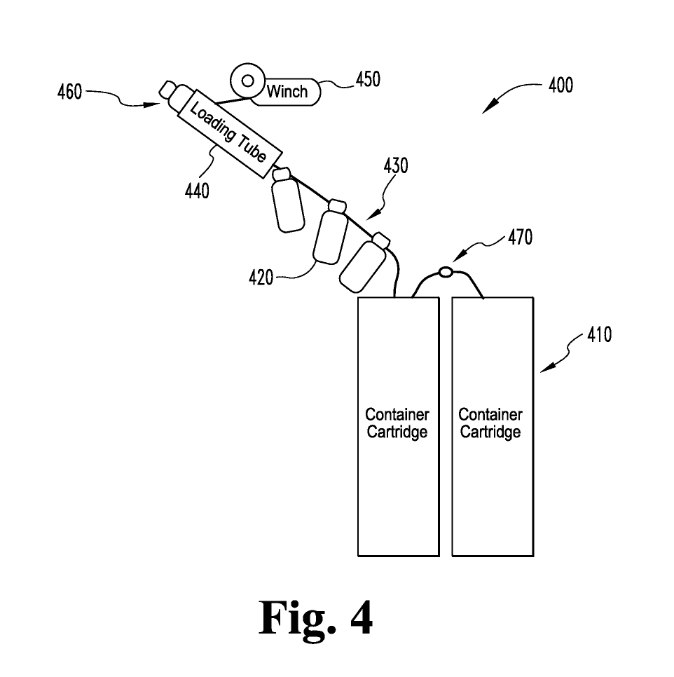

A novel container-loading subsystem 400 is illustrated in FIG. 4. In this illustrated embodiment, a dispensing machine is supplied with two or more “container cartridges” 410. Each container cartridge 410 contains a plurality of empty containers 420 connected in a continuous string by linkages 430, such as a long string or cord, magnetically latched linkages, or other linkages as will occur to those skilled in the conveyor art. When the container cartridges 410 are loaded into a dispensing unit, one end of the linkage chain in a first container cartridge 410 is fed through loading tube 440 and onto winch 450. Connectors 470 connect the linkage chains from two container cartridges each, making the container linkages in the plurality of container cartridges 410 into a single, continuous chain. As beverages are dispensed, winch 450 pulls linkages 430 through loading tube 440 so that individual containers 420 are presented at end 460 of loading tube 440 for filling and dispensing. When the last container 420 is drawn out of the first container cartridge 410, connector 470 allows the winch 450 to continue operation uninterrupted, pulling the first container 420 from the next container cartridge 410.

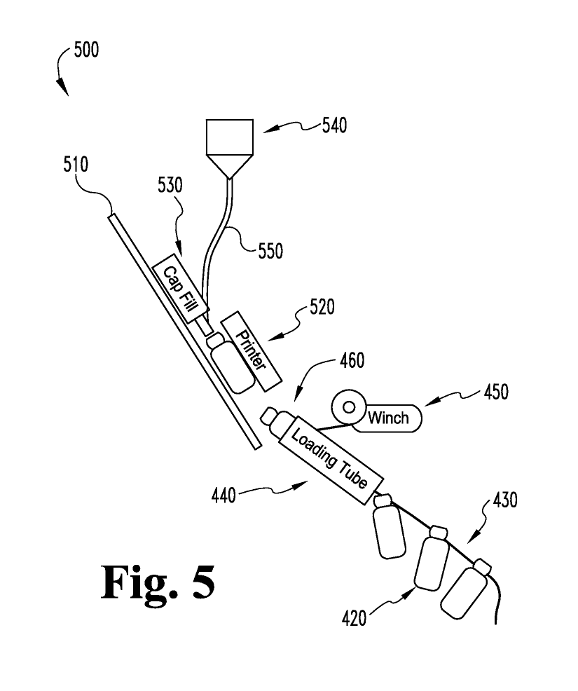

The beverage production mechanism 500 used in some embodiments is illustrated in FIG. 5. Chain of containers 420, connected in a chain by linkages 430, are fed through loading tube 442 to end 460 by operation of winch 450 as discussed in connection with FIG. 4. Moose a container 420 from and 460 of loading tube 440 until its body is aligned with printer 520 and its opening is aligned with cap/fill mechanism 530. Cap/fill mechanism 530 removes any cap already present, fills the container 420, and recaps it if necessary. In some embodiments, filling can occur while the label is being printed by printer 520 onto the container 420.

Ingredient mixing and delivery system 540 is where ingredients are combined and poured into containers 420. Ingredient mixing and delivery system 540 includes a mixing head with water and/or carbonated water, which are injected in appropriate amounts to create an agitated mass of liquid. Flavoring agents and additives are delivered from micro-dosing pumps, or other mechanisms as will occur to those skilled in the art, into the swirling mass for mixing. A valve then releases the liquid for delivery into the container 420 through tube 550. A rinse cycle cleans the mixing chamber before the next drink is mixed.

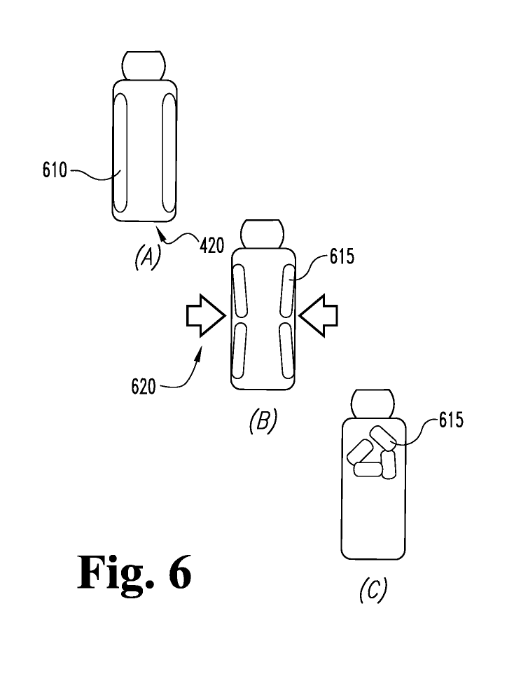

A feature of some dispensing units in systems according to this disclosure is in-container ice, which will be described in connection with FIGS. 6A-6C. In such embodiments, the dispensing unit includes an additional mechanism that coats the inside of a container 420 with ice when requested by the user or provided as part of the formula for the drink being dispensed. This mechanism might insert a spray nozzle into the container 420 as the container 420 itself is being rapidly chilled; very cold water is sprayed as a mist onto the inner surface of container 420, and it freezes to form ice layer 610. Ice layer 610 then keeps the beverage cold like ice in a glass. The user can squeeze the sides of container 420 (as illustrated with arrows 620 in FIG. 6B), breaking ice layer 610 into pieces 615, which float in the beverage and chill the drink throughout.

The described systems are advantageous for buyers of soft drinks, designers of beverages and containers, and technicians who service dispensing units. From the perspective of a buyer of the beverage, the beverages are created in and dispensed from dispensing units such as dispensing unit 210. The buyer approaches the dispensing unit and swipes a credit card or community loyalty card using reader 240 (see FIG. 2) to log into their account on the community platform 220. The buyer in some embodiments additionally or alternatively uses the touchscreen display 230 to indicate that they want to make a purchase. In that case, the system prompts the user for a username and password, and the user supplies that information via the touchscreen 230. Other authentication schemes may also be used as will occur to those skilled in the art.

After login, the machine retrieves the user's profile from the online community platform 220 and displays the user's recent drink purchases, frequently purchased drinks, and drinks suggested by the platform's recommendation engine 380. The user's purchase and rating history, along with the user's profile, is stored in the community's databases 310. In this embodiment, the user may purchase any of those beverages or browse all drinks available in the system. (In others, the selections may be limited.) Based on vending control rules 330, some drink selections may not be displayed to the particular user. Once the user has made a drink selection, they may purchase the drink with no modifications, or if the drink designer has decided to make some of the drink ingredients modifiable, the user may make adjustments to the characteristics the designer has set as modifiable. If the user chooses to adjust the drink ingredients, they will be given the option to adjust the gradations on select ingredients within the drink, for example, increasing the amount of carbonation, replacing one sweetening agent with another, or adding a flavor such as cherry. The user might also select one of a series of variations on a drink if the drink designer has provided them.

Once the user has made their beverage selection, the system will collect payment for the purchase. If the user does not have payment information (such as a credit card) stored in connection with their account, the system will prompt the user to swipe a credit or debit card through the card swipe 240, or insert cash. These steps to place an order can also occur from a smart phone or other mobile device 370 such as an IPHONE or IPOD. A casual user who does not have an account in the system can also make a purchase from a select range of drinks using a credit or debit card, cash or other form of payment without logging into the community platform 220.

When the order has been paid for, the system will advance the container linkages 430 with the winch 450, pulling an empty container 420 out of a container cartridge 410. In this example, container 420 is a bottle, and the cap/fill mechanism 530 uncaps it. The system then moves the container 420 into position in the view window 250, prints the container label using the printer 520, and mixes the ingredients required for the drink by dispensing them into the container 420 using the ingredient mixing and delivery system 540, caps the container 420, then release the container 420 through the vending port 260. The filling of the container and manipulation of container cap are accomplished with the cap and fill mechanism 530.

One optional feature the system offers the user is in-container ice. If the user selects this option, the system will coat the container 420 with a thin shell of ice 610 prior to dispensing the beverage. The beverage mixture will be automatically adjusted to compensate for the addition of this ice to the container, which would otherwise represent surplus water in the drink. After the drink container 420 is dispensed, the user can then gently squeeze the sides of the container 420 to crack the ice shell 610 and release crushed ice 615 into their beverage.

A user may also interact with the system as a drink designer. To design a new beverage, the user logs into their account in the community platform 220 from a personal computer 360, mobile device 370, or similar device capable of interfacing with the platform 220. Once logged into their account, the designer can access the “Build a Drink” section 350 of the community platform 220.

The “Build a Drink” module 350 of the website or other community interface, such as a smart phone application, gives the user an interface to specify which ingredients they wish to include in a drink and to determine the gradations for each ingredient. In some embodiments, the base of each drink is purified water, while in others, the base may be carbonated water, tap water, mineral water, fruit or vegetable juice, milk, or other liquids as will occur to those skilled in the art. Available ingredients include but are not limited to carbonation, sweeteners, colors, flavoring agents, vitamins and other functional ingredients, caffeine, and acids. The system allows the user to pick the ingredients, then adjust the ingredients, name the drink, specify whether the drink has any ingredients that a purchaser will be allowed to modify, and design their own drink label using the label designer module 390 of the community platform 220. The label designer module 390 lets the user add text and graphics to the beverage container label. A library of images is available, which the user can supplement with their own uploaded images, or with online resources such as photos from FACEBOOK, TWITTER, FLICKR, or online photo albums. In some embodiments, the Build a Drink module 350 includes a photo/image editor for use in creating the label.

In some embodiments, at least some dispensing units 210 (see FIG. 2) also include a camera capable of capturing an image of the person purchasing the beverage. In some of these embodiments, drink designer module 350 enables the drink designer to create a custom label for the beverage container that includes at least a portion (for example, an automatically cropped version of the image that only shows the nearest person's face) of the image taken. In other embodiments, the consumer can choose to have such an image placed on the label whether or not the drink designer has specified a location for that image.

Once the designer has finalized their drink, they submit it for review. The staff or select members of the community review the drink ingredients, name, and the label content. This review is for basic liability issues and appropriateness of the name and images—the system will not allow the user to go outside of safe ranges when setting ingredient gradations. If no issues are found in the review, the drink is made available within the system for purchase and is announced to the social hub 320. It can thereafter be ordered from any dispensing unit 210. Otherwise, the drink is returned to the user with an explanation of the issues found, giving the user an opportunity to correct these issues and re-submit their drink.

Individuals referred to here as “technicians” maintain the network of dispensing units. Technicians perform tasks such as loading cartridges 410 of empty containers 420, installing new cells of ingredients and ink for container labels, and other routine maintenance tasks. For such routine tasks, the technician requires no special training or particular skill

The dispensing unit 210 is capable of connecting to the community platform 220. The dispensing unit 210 is capable of communicating over Ethernet, Wi-Fi, cellular networks or other wide-area network technologies. Each dispensing unit 210 monitors its current stock of consumable items, such as printer ink, containers 420 and beverage ingredients, and can signal the field logistics module 340 of community platform 220 for resupply when an ingredient runs low.

Replacement ingredients can be shipped via UPS or a similar carrier, and the technician can replace a container cartridge 410 or ingredient cell as needed. Ingredient cells can easily and quickly be replaced either en masse or individually.

In one embodiment, dispensing units 210 can use locally delivered water that is run through a filtration system to create neutral water for use in beverages. In another embodiment, the dispensing unit uses tanks of neutral water that are delivered to the site and connected by the technician. The technician can also replace used filters and attend to other physical needs of the machine.

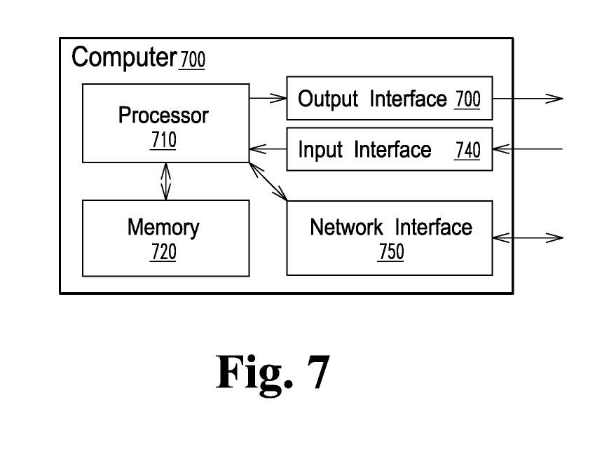

FIG. 7 illustrates the basic components of various computing devices mentioned in this disclosure or used with the systems described herein. Computer 700, as this example will generically be referred to, includes processor 710 in communication with memory 720, output interface 730, input interface 740, and network interface 750. Power, ground, clock, and other signals and circuitry are omitted for clarity, but will be understood and easily implemented by those skilled in the art.

With continuing reference to FIG. 7, network interface 750 in this embodiment connects computer 700 to or through a data network (such as a direct or indirect connection to community platform 220) for communication of data between computer 700 and other devices attached to the network. Input interface 740 manages communication between processor 710 and one or more pushbuttons, UARTs, IR and/or RF receivers or transceivers, decoders, or other devices, as well as traditional keyboard and mouse devices. Output interface 730 provides a video signal to display 760, and may provide signals to one or more additional output devices such as LEDs, LCDs, or audio output devices, or a combination of these and other output devices and techniques as will occur to those skilled in the art.

Processor 710 in some embodiments is a microcontroller or general purpose microprocessor that reads its program from memory 720. Processor 710 may be comprised of one or more components configured as a single unit. Alternatively, when of a multi-component form, processor 710 may have one or more components located remotely relative to the others. One or more components of processor 710 may be of the electronic variety including digital circuitry, analog circuitry, or both. In one embodiment, processor 710 is of a conventional, integrated circuit microprocessor arrangement, such as one or more CORE 17 processors from INTEL Corporation of 2200 Mission College Boulevard, Santa Clara, Calif. 95052, USA, or ATHLON, PHENOM, or FX-Series processors from Advanced Micro Devices, One AMD Place, Sunnyvale, Calif. 94088, USA, or POWER6 processors from IBM Corporation, 1 New Orchard Road, Armonk, N.Y. 10504, USA. In alternative embodiments, one or more application-specific integrated circuits (ASICs), reduced instruction-set computing (RISC) processors, general-purpose microprocessors, programmable logic arrays, or other devices may be used alone or in combination as will occur to those skilled in the art.

Likewise, memory 720 in various embodiments includes one or more types such as solid-state electronic memory, magnetic memory, or optical memory, just to name a few. By way of non-limiting example, memory 720 can include solid-state electronic Random Access Memory (RAM), Sequentially Accessible Memory (SAM) (such as the First-In, First-Out (FIFO) variety or the Last-In First-Out (LIFO) variety), Programmable Read-Only Memory (PROM), Electrically Programmable Read-Only Memory (EPROM), or Electrically Erasable Programmable Read-Only Memory (EEPROM); an optical disc memory (such as a recordable, rewritable, or read-only DVD or CD-ROM); a magnetically encoded hard drive, floppy disk, tape, or cartridge medium; or a plurality and/or combination of these memory types. Also, memory 720 is volatile, nonvolatile, or a hybrid combination of volatile and nonvolatile varieties.

In some novel embodiments, one user of the platform “designs” a formula-based item like a beverage, perfume, candle, sunblock, and the like by using a user interface on a website, computer application, mobile app, kiosk, or other computing device. Others (“purchasers” or “consumers” in this embodiment) at dispensing units around the world can instantly access/purchase the item by reference to the designer's name or identifier, a link in an e-mail message or social media post, a QR code on advertising display, suggestion of a recommendation engine, and any of a variety of other methods by which an item could be selected or a name, number, or other token of information could be transmitted as will occur to those skilled in the art. The purchasers can order the items for delivery or can go to mechanical dispensing units (stocked with materials and ingredients to make the items) and buy them. In some of these embodiments, the designer is compensated when consumers purchase items using formulas they design.

A novel application of the concepts disclosed herein is the instant distribution of new formula-based products. With a design component in data communication with a number of geographically distributed dispensing units, each pre-loaded with a plurality of ingredients, a designer's work product (both in mixed-ingredient content and in packaging) is made available instantly to purchasers at each dispensing unit, both in content and branding, without the cost and delay of establishing a manufacturing and distribution channel. Appropriate nutritional information, lot information, and shelf-life dates are calculated on the spot using the relevant, known characteristics of each ingredient, compiled at the time the formula is created and/or when the item is produced.

In some embodiments, users can order drinks online, then pick them up at any dispensing unit that is connected to community platform 220. In many embodiments, those ordering drinks designed by others have no access to the formulas used to make those drinks. In this way, confidential and proprietary formulas can be maintained.

As another example, one can purchase drinks online for a party, meetup, or corporate event. A list of invitees or attendees is uploaded, and a custom drink and/or label is created for each, perhaps with a component that is common to all displaying the host's or sponsor's brand. An extra-special invitation to the event might be a copy of the beverage or a printed (or emailed) card or token that the invitee can bring to a connected dispensing unit to receive their custom drink.

Yet another example is a meetup where each name tag is on a peelable label on a bottle filled with their preselected drink from the community platform. When they arrive, they can then peel their name tag off and put it on their clothing, then enjoy their favorite beverage.

In some embodiments, apps running on mobile devices 370 use the location-awareness functionality and data connectivity of the device to easily determine the nearest location of a dispensing unit. Some of these embodiments integrate or connect with GPS and direction-giving functions to automatically provide directions to that dispensing unit.

In alternative embodiments, dispensing units produce items other than or in addition to beverages. For example, dispensing units can analogously produce flavored items like hot sauces, syrups, coffee additives, alcohol mixers, and cake batter, or scented items like candles and air fresheners.

In other alternative embodiments, the various databases 310 include more or fewer databases, tables, and data elements as will occur to those skilled in the art.

In this disclosure, “remote” refers to data processing devices that are connected through a data network, though they might be in physical proximity. As a nonlimiting example, a person may have a cellular telephone or smart phone on their person as they purchase a beverage from a dispensing unit as described herein. Data communications between the telephone or smart phone and the dispensing unit in such a situation are likely to pass through the cellular data network, one or more Internet backbones and routers controlled by third parties, and through a local data link to the dispensing unit. Despite their physical separation being only a few feet, these devices are “remote” within the meaning ascribed to the term in this disclosure.

All publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A system for vending custom items, comprising:
a plurality of dispensing units in different locations, each comprising:
a plurality of ingredient dispensers, each containing one or more of a plurality of ingredients;
a first processor; and
a first memory in communication with the first processor, the first memory being encoded with first programming instructions; and
a computing device comprising a second processor and a second memory in communication with the processor, the second memory being encoded with second programming instructions executable by the second processor to:
accept user input of a particular formula from a designer for a product containing a mixture of two or more of the plurality of ingredients; and
communicate the particular formula to the plurality of dispensing units;
wherein the first programming instructions are executable by the first processor to:
control the ingredient dispensers to mix the two or more of the plurality of ingredients to produce an item according to the particular formula;
dispense the item to a consumer proximate to the dispensing unit.

2. The system of claim 1, wherein the ingredients are all liquid.

3. The system of claim 1, wherein the input of the formula is given to the computing device through a graphical mixture-building interface.

4. The system of claim 1, wherein the second programming instructions are further executable by the second processor to accept and store a comment from the consumer regarding the item.

5. The system of claim 4, wherein the second programming instructions are further executable by the second processor to recommend a different item to the consumer as a function of the comment.

6. The system of claim 4, wherein the second programming instructions are further executable by the second processor to:
accept evaluation input from a censor regarding the comment; and
if the evaluation input indicates that the comment is appropriate, publish the comment.

7. The system of claim 1, wherein
a record of the dispensing is associated with a user profile of the consumer; and
the computing device stores event data registering the dispensing in connection with the user profile.

8. The system of claim 7, wherein the first programming instructions are further executable by the first processor to:
detect the identity of the consumer;
transmit information related to the identity of the person to the computing device; and
responsively to the transmission, receive from the computing device formula data sufficient to encode one or more formulas, the one or more formulas comprising the particular formula;
wherein the one or more beverage formulas are associated in a database with the identity of the person.

9. The system of claim 8, wherein the first programming instructions are further executable by the first processor to initiate a payment transaction for the item being dispensed as a function of the identity of the consumer.

10. The system of claim 1, wherein
the specific formula is selected as a function of information in a user profile of the consumer before the computing device receives the transmission.

11. The system of claim 10, wherein the formula is selected by the remote computing device as a function of output of a recommendation engine.

12. The system of claim 11, where the recommendation engine uses a social network of the consumer as input.

13. The system of claim 1, wherein the specific formula is selected from a plurality of available formulas as a function of a particular event occurring at a time, date, and location nearby the time, date, and location at which the item is being dispensed.

14. The system of claim 1, wherein only a subset of the ingredients is available to the consumer under one or more particular conditions selected from the condition group consisting of:
a range of times of day;
one or more particular days of the week; and
a role of the consumer in an organization.

15. The system of claim 1,
further comprising a register in which the system records the number of times the formula is used to dispense an item, and
wherein a benefit is given to the designer as a function of the number of times.

16. The system of claim 15, wherein the benefit is monetary.

17. The system of claim 15, wherein the benefit is a badge associated with a profile of the designer on a social network.

18. The system of claim 1,
wherein the second programming instructions are further executable by the second processor to receive design data sufficient to encode content for a custom label, and
the dispensing units further comprise a printer that prints the content on a label for the item during the dispensing process.

19. The system of claim 18,
each of the dispensing units further comprising a camera in communication with the first processor;
wherein the printer includes at least a portion of a photograph taken by the camera in the custom label.

20. The system of claim 1,
each of the dispensing units further comprising a plurality of containers; and
the first programming instructions being further executable to dispense the item in one of the plurality of containers.
